(19) United States
(12) Patent Application Publication
(10) Pub. No.: US 2008/0185288 A1
(43) Pub. Date: Aug. 7, 2008

(54) DETECTION ELEMENT

(75) Inventor: Shinobu Yokokawa, Fujimi-machi (JP)

Correspondence Address: OLIFF & BERRIDGE, PLC, P.O. BOX 320850, ALEXANDRIA, VA, 22320-4850, US

(73) Assignee: Seiko Epson Corporation, Tokyo (JP)

(21) Appl. No.: 12/026,215

(22) Filed: Feb. 5, 2008

(30) Foreign Application Priority Data
Feb. 6, 2007 (JP) 2007-027361

(51) Int. Cl. B01D 59/44

(52) U.S. Cl. 204/418

(57) ABSTRACT

A detection element includes a detector by which a salt or an ion in an analyte is detectable. The detector includes a base and a reaction layer disposed on the base. The reaction layer has a polymer that has a main chain with an end thereof linked to the base, and a side chain branched from the main chain. The side chain contains an ion-trapping part in which an ion constituting the salt or the ion is trappable.

The entire disclosure of Japanese Patent Application No. 2007-027361, filed Feb. 6, 2007 is expressly incorporated by reference herein.

### BACKGROUND OF THE INVENTION

1. Technical Field

The present invention relates to a detection element.

2. Related Art

If a sample solution (analyte) is brought into contact with a functional membrane having a selective ion-exchange capacity for an object ion, the membrane potential linearly varies in a wide range with respect to the logarithm of the activity of the object ion that exists in the sample solution.

An ion sensor (detection element) having such a functional membrane as an ion sensitive film has been developed (see, e.g., JP-A-2002-131273).

In the ion sensor, an ion sensitive film is made such that an ionophore that can selectively trap an object ion is dispersed in a thermoplastic resin by a plasticizer.

In an ion sensitive film having such a structure, a sample solution shifts to the inside of the ion sensitive film (thermoplastic resin) such that the ion sensitive film swells, and an ionophore is released from the ion sensitive film by temperature changes and the like.

As a result, the responsibility of the ion sensor to the object ion varies.

Moreover, penetration of a sample solution may cause the ion sensitive film to partially collapse and to be removed from the ion sensor.

A longterm stable use of the ion sensitive film is not ensured.

Further, if a thermosetting resin is used in place of the thermoplastic resin, compatibility with a plasticizer becomes insufficient to decrease the amount of an ionophore in an ion sensitive film.

As a result, there is a problem that the life stability of the ion sensor is insufficient.

Thus, an ion sensor described in JP-A-2002-131273 has some problem in terms of high sensitivity, life stability and the like in the structure of the ion sensitive film.

An advantage of the invention is to provide a detection element that can detect a salt or an ion with good accuracy and long-term stability.

This advantage is achieved by the following aspect of the invention.

A detection element according to an aspect of the invention is a detection element that includes a detector by which one of a salt and an ion in an analyte is detectable, the detector including a base and a reaction layer disposed on the base.

The reaction layer has a polymer that has a main chain with an end thereof linked to the base, and a side chain branched from the main chain.

The side chain contains an ion-trapping part in which one of an ion constituting the salt and the ion is trappable.

With this detection element, a salt or an ion can be detected with good accuracy.

The ion-trapping part is linked to the side chain of the polymer.

This can securely prevent deviation of the ion-trapping part from the reaction layer.

Therefore, the detection element can be preferably prevented from deterioration with time (decrease of detection sensitivity).

In the detection element according to the aspect of the invention, it is preferable that the ion-trapping part have a cyclic structure and have a function of trapping the ion into the cyclic structure based on a difference in kind and/or ion size of the ion.

The ion-trapping part has the cyclic structure (ionophore), allowing various ions to be trapped and maintained with more reliability.

As a result, the sensitivity of detection by the detection element can be improved.

In the detection element according to the aspect of the invention, it is preferable that the cyclic structure contain at least one kind of an oxygen atom, a nitrogen atom and a sulfur atom.

This cyclic structure is preferable because it has a very high ion-trapping capacity.

This structure also has an advantage that the sizes (inside spaces) and flexibility of rings are easy to adjust, allowing the cyclic structure to be synthesized with relative ease.

In the detection element according to the aspect of the invention, it is preferable that the ion-trapping part further have a coordination structure for coordination to the ion trapped in the cyclic structure.

The coordination of the coordination structure to the ion trapped in the cyclic structure causes the ion to be in such a state as to be covered with a lid.

This allows the ion trapped in the cyclic structure to be maintained with more reliability.

In the detection element according to the aspect of the invention, it is preferable that the coordination structure be located between the cyclic structure and the main chain.

In this way, the cyclic structure with the ion trapped therein is folded onto the side of the main chain to coordinate to the coordination structure.

In other words, the ion is trapped along and in the vicinity of the main chain.

Therefore, in the case where a trapping state and a non-trapping state are electrically detected, electron transfer along the main chain is performed smoothly.

This enables an increase in the amount of an electric current taken out, that is, improvement in sensitivity of detection by the detection element.

In the detection element according to the aspect of the invention, it is preferable that the detector include a plurality of detectors.

In this way, a plurality of salts or ions can be concurrently detected.

In the detection element according to the aspect of the invention, it is preferable that the detector include a plurality of detectors, and the plurality of the detectors each have a different kind of the cyclic structure.

In this way, the amount of single salts or ions in the analyte can be detected even by using a general ion-trapping part.

In the detection element according to the aspect of the invention, it is preferable that the detection element be configured to detect a difference between a non-trapping state where the polymer has the ion without being trapped in the ion-trapping part and a trapping state where the polymer has the ion trapped in the ion-trapping part based on a variation in electric characteristic of the reaction layer.

In this way, the salt or the ion can be detected with good accuracy in a simple configuration.

In the detection element according to the aspect of the invention, it is preferable that the polymer have an electron transfer assistance part for assisting transfer of an electron.

The polymer has an electron transfer assistance part, causing electron transfer along the main chain to be performed smoothly.

As a result, the amount of an electric current taken out can be further increased, that is, the sensitivity of detection by the detection element can be improved.

In the detection element according to the aspect of the invention, it is preferable that the polymer have the electron transfer assistance part in a side chain branched from the main chain.

The electron transfer assistance part is linked through a side chain containing an oxygen atom or a nitrogen atom to the main chain, allowing coordination to the ion trapped in the ion-trapping part.

In this way an effect is obtained that enables the ion-trapping part can maintain the ion with more reliability.

In the detection element according to the aspect of the invention, it is preferable that the detection element be configured to detect a difference between a non-trapping state of the polymer without the ion trapped in the ion-trapping part and a trapping state of the polymer with the ion trapped in the ion-trapping part based on a variation in mass of the reaction layer.

In this way, the salt or the ion can be detected with good accuracy in a simple configuration.

In the detection element according to the aspect of the invention, it is preferable that the detection element be configured to detect a difference between a non-trapping state of the polymer without the ion trapped in the ion-trapping part and a trapping state of the polymer with the ion trapped in the ion-trapping part based on a variation in refractive index of the reaction layer.

In this way, the salt or the ion can be detected with good accuracy in a simple configuration.

### BRIEF DESCRIPTION OF THE DRAWINGS

The invention will be described with reference to the accompanying drawings, wherein like numbers reference like elements.

FIG. 1 is a schematic view (perspective view) illustrating a state of a detection element of a first embodiment attached to a measurement device.

FIG. 2 is a plan view illustrating an enlarged part of the detection element illustrated in FIG. 1.

FIG. 3 is a sectional view taken along the line A-A of the detection element illustrated in FIG. 2.

FIGS. 4A and 4B are partially enlarged views of the sectional view illustrated in FIG. 3.

FIGS. 5A to 5C are drawings (longitudinal sectional views) for explaining a manufacturing method of the detection element illustrated in FIG. 1.

FIG. 6 is a schematic view illustrating one example of a polymer.

FIG. 7 is a schematic view for explaining formation of a reaction layer (polymer).

FIG. 8 is a schematic view for explaining formation of a reaction layer (polymer).

FIG. 9 is a schematic view for explaining formation of a reaction layer (polymer).

FIG. 10 explains a method for detecting the amount of single ions.

FIG. 11 is a longitudinal sectional view illustrating a detector that a detection element of a second embodiment has.

FIG. 12 is a plan view illustrating a detector that a detection element of a third embodiment has.

FIG. 13 is a sectional view taken along the line B-B in FIG. 12.

FIG. 14 is a longitudinal sectional view illustrating a detector that a detection element of a fourth embodiment has.

FIG. 15 is a schematic view (perspective view) illustrating a configuration of a measurement device to which the detection element illustrated in FIG. 14 is applied.

FIG. 16 is a graph illustrating variations in light amount observed by the measurement device illustrated in FIG. 15.

### DESCRIPTION OF EXEMPLARY EMBODIMENTS

Preferred embodiments of a detection element of the invention will be described below.

### First Embodiment

A first embodiment of a detection element of the invention will first be described.

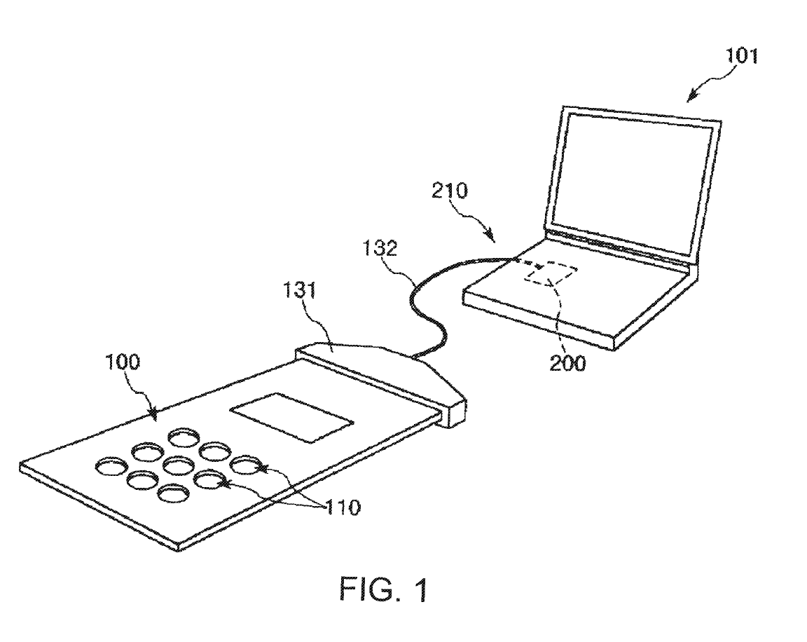

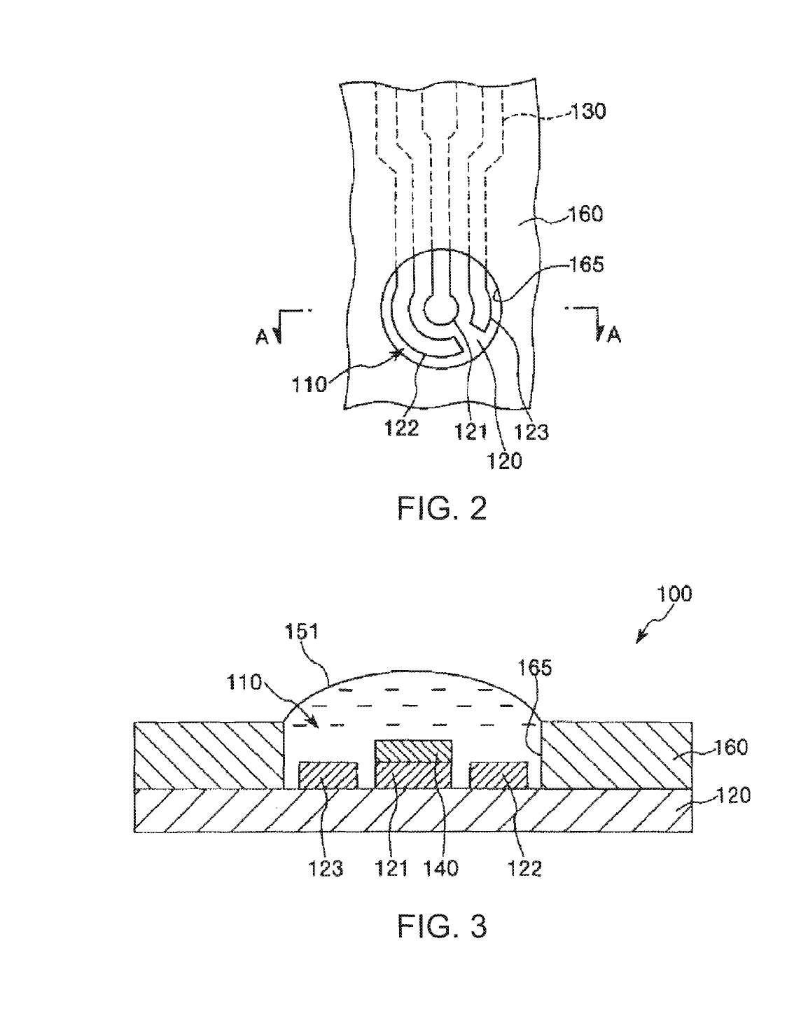

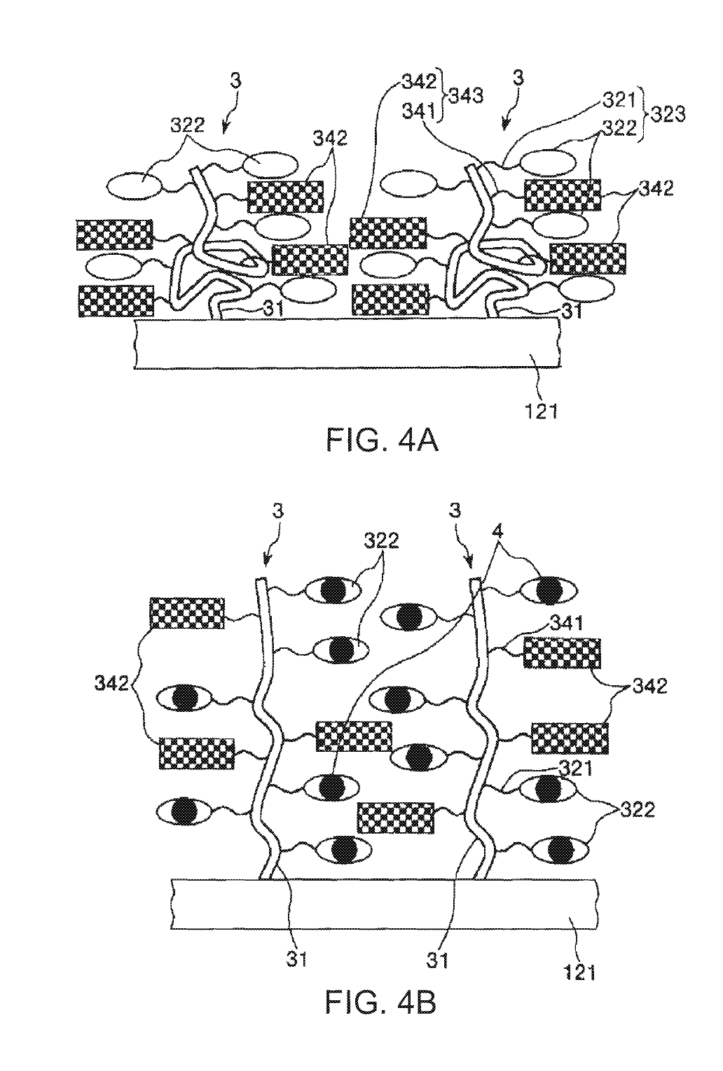

FIG. 1 is a schematic view (perspective view) illustrating a state of a detection element of the first embodiment attached to a measurement device, FIG. 2 is a plan view illustrating an enlarged part of the detection element illustrated in FIG. 1, FIG. 3 is a sectional view taken along the line A-A of the detection element illustrated in FIG. 2, and FIGS. 4A and 4B are partial enlarged views of the sectional view taken along the line A-A illustrated in FIG. 3.

It should be noted that the upper and lower sides in the description below mean the front and back sides of the drawing in FIG. 2 and the upper and lower sides of the drawings FIGS. 3, 4A and 4B.

A measurement device 101 illustrated in FIG. 1 is for use with a detection element 100 connected thereto, and includes an arithmetic unit 210 having a processing circuit 200 that analyzes an electric current value obtained in the detection element 100, a connector 131 that attaches (connects) the detection element 100, and wiring 132 that connects the processing circuit 200 with the connector 131.

The detection element 100 has a plurality of detectors 110, each including a working electrode 121, a counter electrode 122 and a reference electrode 123, on a substrate 120 as illustrated in FIGS. 2 and 3.

Each of the electrodes 121, 122 and 123 independently establishes an electric connection through wiring 130, the connector 131 and wiring 132 to the processing circuit 200.

The detection element 100 can be connected to the connector 131 in a freely attachable/detachable manner.

The substrate 120 supports units constituting the detection element 100.

Examples of a material for forming the substrate 120 include various kinds of resin materials such as polyethylene, polypropylene, polystyrene, polyethyleneterephtalate (PET), polyethylene naphthalate (PEN) and polyimide (PI); various kinds of glass materials such as quartz glass; and various kinds of ceramics materials such as alumina and zirconia.

These materials may be used in one kind alone or in a combination of two or more kinds.

Examples of materials for forming the electrodes 121, 122 and 123 include metal materials such as gold, silver, copper and platinum or alloys containing these metals; metal oxide materials such as indium-tin-oxide (ITO); and carbon materials such as graphite.

As illustrated in FIGS. 2 and 3, an insulating film 160 is provided as to cover the wiring 130 over the substrate 120.

Formed in the insulating film 160 are a plurality of openings 165, and a set of electrodes 121, 122 and 123 are exposed in each opening 165.

Provided on the working electrode 121 is a reaction layer (ion sensitive layer) 140 to be described later.

The inside of each opening 165 constitutes the detector 110.

In the detection element 100 configured as mentioned above, when an analyte liquid 151 is supplied in the detector (space into which a sample is supplied) 110, the analyte liquid 151 is brought into contact with the reaction layer 140 as illustrated in FIG. 3.

Targets 4 in the analyte liquid 151 are trapped into the reaction layer 140.

With the targets 4 trapped into the reaction layer 140, electric characteristics of the reaction layer 140 vary.

Accordingly, the amount of the targets 4 in the analyte liquid 151 can be measured on the basis of the variation in electric characteristics.

Examples of the variation of electric characteristics of the reaction layer 140 include a variation in the amount of an electric current that can be taken out from the working electrode 121 and a variation in resistance value of the reaction layer 140.

Here, in the case where the analyte (sample) is a liquid, the analyte liquid 151 is obtained without any adjustment or with adjustment of its capacity such as dilution, as needed.

Examples of the liquid analyte include body fluids such as blood, urine, sweat, lymph, cerebrospinial fluid, bile and saliva; wastewater such as domestic wastewater and industry wastewater; and stored water such as water in a pool and water in a water storage tank; or treated liquids thereof that have been subjected to various treatments.

In the case of using a solid analyte such as a cell, soil and mineral, for example, the solid analyte is ground, suspended in a polar solvent, and extracted from the solvent, thereby enabling the analyte liquid to be obtained.

Examples of the extractant include water, methanol (MeOH), ethanol (EtOH), isopropyl alcohol (IPA), N,N-dimethylformanide (DMF), dimethyl suboxide (DMSO), acetonitrile (MeCN) and propylene carbonate (PC), and mixed solutions thereof.

The detection element 100 of one embodiment of the invention can trap ions constituting salts or ions as the targets 4 in the reaction layer 140.

Examples of the targets (targeting object) 4 include metal ions of alkali metals such as Na and K and alkaline earth metals such as Mg and Ca; and the foregoing metallic ions constituting inorganic salts or organic salts such as quaternary ammonium salt.

The reaction layer 140 of the embodiment is made of an aggregate of a polymer 3.

As illustrated in FIGS. 4A and 4B, each polymer 3 includes the main chain 31, ion-trapping parts 322 each linked through a first linking body 321 to the main chain 31, and electron transfer assistance parts 342 each linked through a second linking body 341 to the main chain 31.

The first linking body 321 and the ion-trapping part 322 constitutes a first side chain 323, and the second lining body 341 and the electron transfer assistance part 342 constitutes a second side chain 343.

The main chain 31 has a straight chain form, and its one end is attached to the working electrode 121.

The main chain 31 is preferably synthesizable by living polymerization to be described later so as to introduce side chains such as the first and second side chains 323 and 343 into any portions.

The main chain 31 as mentioned above is not particularly limited.

In view of the ease of synthesization by living polymerization, however, ones mainly made of hydrocarbon chains (particularly saturated hydrocarbon chains) are preferably used as the main chain 31.

The ion-trapping part 322 has a function of trapping, with high selectivity ions themselves that are the targets 4 or ions constituting salts that are the targets 4.

Examples of the ion-trapping part 322 include, ones containing cyclic structures (ionophore) that trap the foregoing ions in their inside spaces based on the differences in kind and/or size of the ions, and ionic groups to be electrically bound to the ions, such as SO₃⁻ group, CO₂⁻ group, PO₄H⁻ group and NH₃⁺ group.

In particular, ones containing ionophores are preferable.

Using the ones containing ionophores as the ion-trapping part 322 allows various ions to be trapped and maintained with more reliability based on the differences in kind and/or size of the ions.

As a result, the sensitivity of detection by the detection element 100 can be improved.

Examples of the ionophore (cyclic structure) include ones each containing at least one kind of an oxygen atom, a nitrogen atom and a sulfur atom (that is, ones in which methylene groups are bound to each other by an oxygen atom, a nitrogen atom or a sulfur atom); and ones made of methylene groups only (hydrocarbon ring).

In particular, ones in which methylene groups are bound to each other by an oxygen atom, a nitrogen atom or a sulfur atom (hetero atom) are preferable.

Such ionophores are preferable because they have structures where the ion-trapping capacity is very high.

The ionophores have an advantage that the sizes (inside spaces) and flexibility of rings are easy to adjust, allowing the ionophores to be synthesized with relative ease.

Examples of the ionophores each containing a hetero atom include crown ether ionophores represented by formula 1, propylene glycol ionophores represented by formula 2, azacrown ionophores represented by formula 3, and sulfide (thioether) ionophores represented by formula 4.

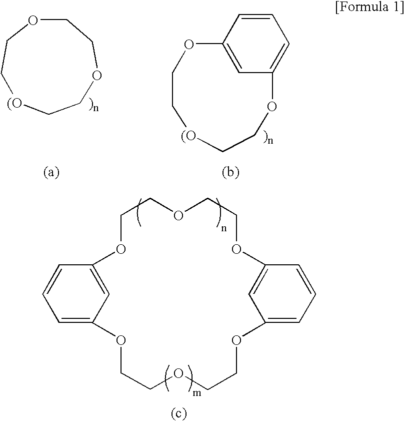

In formulas 1(a) and 1(b), n represents an integer of 1 to 4.

In formula 1(c), n represents an integer of 0 to 2, and m represents an integer of 0 to 2.

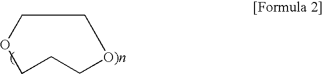

where n represents an integer of 1 to 3.

[Formula 3]

where n represents an integer of 1 to 4.

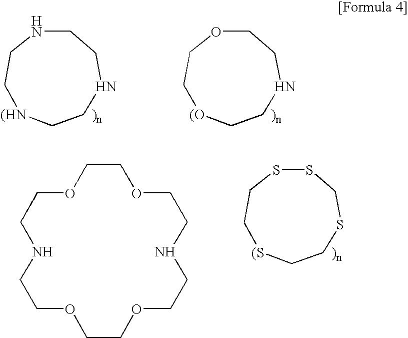

where n represents an integer of 1 to 4.

Here, as n increases, there is a tendency that the cyclic structure (size of the inside space) increases and the size of ions that are trappable increases.

If an aryl group, an unsaturated bond and the like are contained in a cyclic structure, there is a tendency of reducing flexibility of the cyclic structure.

Specifically, for example, an ionophore represented by formula 1(a) wherein n is 3 selectively traps Li ions and Na ions if a solvent controlled in the analyte liquid 151 (hereinafter referred to as a “measuring solvent”) is MeCN; Na ions if the measuring solvent is PC; and Na ions and K ions if the measuring solvent is MeOH.

Also, an ionophore represented by formula 1(b) wherein n is 3 selectively traps Na ions if the measuring solvent is MeCN; Na ions and K ions if the measuring solvent is PC; and Na ions if the measuring solvent is MeOH.

An ionophore represented by formula 1(c) wherein n and m are each 1 selectively traps K ions if the measuring solvent is Me CN; Na ions and K ions if the measuring solvent is PC; Na ions and Ra ions if the measuring solvent is MeOH; and K ions if the measuring solvent is water.

In the case of the ion-trapping part 322 having a cyclic structure (ionophore), it is preferable that the ion-trapping part 322 further has a coordination structure for coordination to ions trapped in the cyclic structure.

The coordination of the coordination structure to ions trapped in the cyclic structure causes the ions to be in such a state as to be covered with a lid.

This allows the ions trapped in the cyclic structure to be maintained with more reliability.

By providing a coordination structure as well as a cyclic structure, a space increased in size can be secured.

Therefore, ions increased in size can be trapped in the ion-trapping part 322 without increasing the size of the cyclic structure.

Further, the coordination structure may be located at a terminal (in the end opposite to that in which the main chain 31 is located) of the ion-trapping part 322, but is preferably located between the cyclic structure and the main chain 31 (that is, in a middle point of the first side chain 323).

In this case, the cyclic structure with ions trapped therein is folded onto the side of the main chain 31 to coordinate to the coordination structure.

In other words, the ions are trapped along and in the vicinity of the main chain 31.

Therefore, in the present embodiment, electron transfer along the main chain 31 is performed smoothly.

This enables an increase in the amount of an electric current taken out from the working electrode 121, that is, improvement in sensitivity of detection by the detection element 100.

Specific examples of the ion-trapping part 322 having such a coordination structure include the following formulas 5 and 6.

It should be noted that these examples are illustrative only, and an oxygen atom contained in the coordination structure portion may be replaced by an atom having other lone-pair electrons such as a nitrogen atom or a sulfur atom.

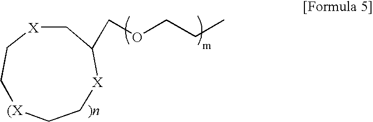

where X independently represents O, N or S, n represents an integer of 1 to 4, and m represents an integer of 1 to 6.

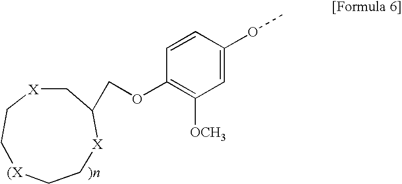

where X independently represents O, N or S, and n represents an integer of 1 to 4.

The number of the ion-trapping parts 322 bound to the main chain 31 is not particularly limited, but is preferably about 2 to 40, and more preferably 5 to 20.

With such the number of ion-trapping parts 322 bound to the main chain 31, the targets 4 can be trapped sufficiently and securely into the reaction layer 140.

On the other hand, the electron transfer assistance part 342 has a function of assisting the transfer of electrons in the reaction layer 140 in taking out an electric current from the working electrode 121.

Accordingly, because the polymer 3 has the electron transfer assistance part 342, electron transfer in the reaction layer 140 is performed smoothly.

As a result, the amount of an electric current taken out from the working electrode 121 can be further increased, that is, detection sensitivity by the detection element 100 can be further improved.

Examples of the electron transfer assistance part 342 include ferrocene, porphyrin, phthalocyanine and methylene blue.

The electron transfer assistance part 342 and the main chain 31 may be directly linked, but is preferably linked through the second linking body 341.

Examples of the second linking body 341 include —(CH₂)ₙNH—, —(CH₂)ₙO—, —(OC₂H₄)NH—, —(OC₂H₄)O—, —(CH₂)ₘO(CH₂)ₙNH— and —(CH₂)ₘO(CH₂)ₙO—.

These examples of the second linking body 341 contain an oxygen atom or a nitrogen atom, and therefore can coordinate to ions trapped in the foregoing ion-trapping part 322.

This enables the ion-trapping part 322 to still securely maintain ions.

It should be noted that each of the foregoing m and n independently represents an integer equal to or greater than 1.

The number of the electron transfer assistance parts 342 bound to the main chain 31 is not particularly limited, but is preferably about 1 to 20, and more preferably about 5 to 10.

With such the number of the electron transfer assistance parts 342 bound to the main chain 31, the amount of an electric current that can be taken out from the working electrode 121 can be increased.

It should be noted that the electron transfer assistance part 342 may be provided as needed, and may be omitted.

The first side chain 323 and the second side chain 343 are branched from the main chain 31.

The ion-trapping part 322 and the electron transfer assistance part 342 are linked to ends of the first side chain 323 and the second side chain 343 through the first linking body 321 and the second linking body 341, respectively.

In the first side chain 323 and the second side chain 343 as mentioned above, the number of carbon atoms linked in a straight chain among atoms constituting the first linking body 321 and the second linking body 341, that is, the number of carbons existing between the ion-trapping part 322 and electron transfer assistance part 342 and the main chain 31 is preferably about 2 to 20, and more preferably about 5 to 10.

Thus, the ion-trapping part 322 and electron transfer assistance part 342 can be linked to the main chain 31 with the spacing distance from the ion-trapping part 322 and electron transfer assistance part 342 to the main chain 31 appropriately maintained.

The density of the polymer 3 attached to the working electrode 121 is preferably about 0.5 to 10 nm²/polymer, and more preferably 1 to 5 nm²/polymer.

With the number of polymers 3 attached to the working electrode 121 set within these ranges, a necessary and sufficient amount of the targets 4 can be trapped.

Linking of the ion-trapping part 322 to a side chain of the polymer 3 attached to the working electrode 121 in this way can securely prevent deviation of the ion-trapping part 322 from the reaction layer 140.

Therefore, the detection element 100 can be preferably prevented from deterioration with time (decrease of detection sensitivity).

In the detection element 100 as described above, as illustrated in FIG. 4A, if there is no target 4 around the polymer 3, the polymer 3 (main chain 31) contracts because of interaction of ion-trapping parts 322 with each other, interaction of electron transfer assistance parts 342 with each other, or interaction of the ion-trapping part 322 and the electron transfer assistance part 342.

On the other hand, as illustrated in FIG. 4B, if the targets 4 are trapped in the ion-trapping part 322 of the polymer 3, the polymer 3 (the main chain 31) expands due to repulsion between the targets 4.

In these two states, different electric current values are obtained from the working electrode 121 in accordance with differences in the entire amount of charge including those in kind, quantity and the like of the trapped targets 4.

In the embodiment, the differences in electric current value taken out from the working electrode 121 are detected between a trapping state where the targets 4 are trapped and a non-trapping state where the targets 4 are not trapped.

However, the mass (weight) and layer thickness (film thickness) of the reaction layer 140 vary between the trapping state and the non-trapping state, and therefore the variation in mass and thickness may also be detected.

A detection element designed to detect such a variation will be described in detail in later embodiments (third and fourth embodiments).

A manufacturing method (synthesization method) of the polymer 3 as described above will be described in detail later.

The counter electrode 122 is an electrode to apply voltage between the working electrode 121 and itself.

With the analyte liquid 151 supplied to the detector 110, when voltage is applied to between the working electrode 121 and the counter electrode 122 such that the working electrode 121 has a higher potential, different electric current values are detected from the working electrode 121 in accordance with whether the targets 4 is trapped in the ion-trapping part 322 or the amount of the trapped targets 4.

The area of the counter electrode 122 is preferably 1.5 times or more that of the working electrode 121, and 10 times or more is more preferable.

Thus, the electric current value can be measured with higher accuracy.

The reference electrode 123 is an electrode to apply voltage between the counter electrode 122 and itself.

With the analyte liquid 151 supplied to the detector 110, voltage is applied to between the reference electrode 123 and the counter electrode 122.

Then, an electric current value flowing between these electrodes is compared with that flowing between the foregoing working electrode 121 and the counter electrode 129.

In this way, a variation in electric current value caused by the targets 4 trapped in the ion-trapping part 322 can be detected (measured) with higher accuracy.

As a constituent material for the reference electrode 123, for example, silver-silver chloride, mercury-mercuric sulfate and the like, in addition to the materials described above, may be used.

The foregoing working electrode 121, the counter electrode 122, the reference electrode 123 and the wiring 130 are preferably made of aggregates of conductive material powder.

This allows these electrodes and wiring to be easily formed using various printing methods.

As a result, manufacturing processes of the detection element 100 can be significantly simplified, allowing reduction of costs of the detection element 100.

The insulating film 160 has the opening 165 as described above, and the analyte liquid 151 is supplied to the inside of the opening 165.

The average thickness of the insulating film 160 is not particularly limited, but is preferably about 10 to 5000 nm, and more preferably about 50 to 1000 nm.

Setting the thickness of the insulating film 160 within these ranges can securely insulate the electrodes 121, 122 and 123 from each other and the wirings 130 from each other.

Next, a manufacturing method of the detection element 100 illustrated in FIG. 1 (particularly a method for forming the reaction layer 140) will be described.

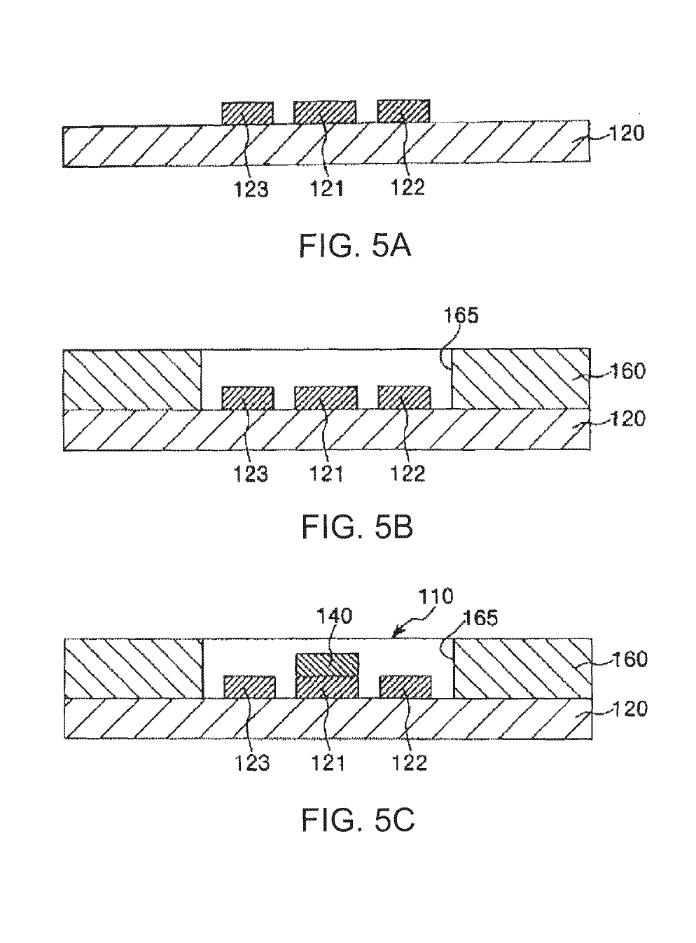

FIGS. 5A to 5C are drawings (longitudinal sectional views) for explaining a manufacturing method of the detection element illustrated in FIG. 1.

It should be noted that the upper and lower sides in the description below mean the upper and lower sides of the drawings in FIGS. 5A to 5C.

1. Initially, the substrate 120 is prepared, and as illustrated in FIG. 5A, the working electrode 121, the counter electrode 122, the reference electrode 123 and the wring 130 are formed on the substrate 120.

These electrodes and the wiring can be formed as follows.

First, a metal film (metal layer) is formed on the substrate 120.

This may be formed by chemical vapor deposition (CVD) methods such as a plasma CVD method, a thermal CVD method and a laser CVD method; vacuum deposition; sputtering (low temperature sputtering); dry plating methods such as ion plating; wet plating methods such as electrolytic plating, immersion plating and electroless plating; spraying; sol-gel methods; metal organic deposition (MOD) methods; joining of metallic foils; and the like.

Next, formed on the metal film is a resist layer having a shape corresponding to those of electrodes and wiring by a photolithography method.

Using this resist layer as the mask, an unrequired part of the metal film is removed.

For the removal of the metal film, physical etching methods such as plasma etching, reactive ion etching, beam etching and photo-assisted etching; chemical etching methods such as wet etching; and the like may be used in one kind alone or in a combination of two or more kinds.

Then, the resist layer is removed so that the electrodes and wiring as the objects of formation are obtained.

Each of the electrodes and wiring may also be formed as follows: that is, a liquid material such as a colloidal liquid (fluid dispersion) containing conductive particles, a liquid (solution or fluid dispersion) containing a conductive polymer is supplied onto the substrate 120 to form a coating film, and thereafter the coating film is subjected to the subsequent treatments (e.g., heating, infrared radiation, application of ultrasonic waves, etc.) as needed.

Examples of a method for supplying such a liquid material onto the substrate 120 include a dipping method, a spin mating method, a casting method, a microgravure coating method, a gravure coating method, a bar coating method, a roll coating method, a wire bar coating method, a dip-coating method, a spray coating method, a screen printing method, a flexographic printing method, an offset printing method, an inkjet method and a micro contact printing method.

These methods may be used in one kind alone or in a combination of two or more kinds.

Among the methods, it is preferable to use, in particular, an inkjet method (droplet discharge method).

By the inkjet method (droplet discharge method), the electrodes and wiring as the objects of formation can be obtained with ease and accuracy in dimension.

2. Next, as illustrated in FIG. 5B, the insulating film 160 having the opening 165 is formed.

This insulating film 160 can be formed by a photolithography method, e.g., by using an organic insulating material (e.g., photopolymer).

This film may also be formed by discharging an organic insulating material in a pattern of the insulating film 160, which is the object of the formation, by a droplet discharge method.

In addition, the insulating film 160 may also be formed using an inorganic insulating material in the same way as for the foregoing electrodes and wiring.

3. Next, as illustrated in FIG. 5C, the reaction layer 140 is formed on the working electrode 121.

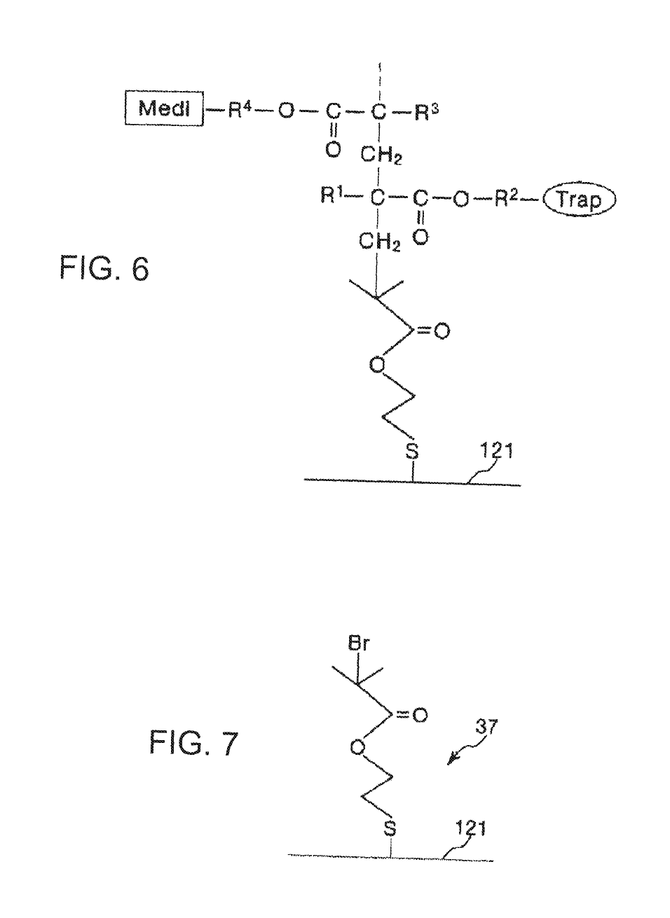

Here, a case of forming (generating) what is illustrated in FIG. 6, as the polymer 3, using a living polymerization method is explained as one example.

FIGS. 7 to 9 are schematic views for illustrating formation of a reaction layer (polymer).

It should be noted that the upper and lower sides in the description below mean the upper and lower sides of the drawings in FIGS. 7 to 9.

3A. First, a compound (A) represented below that has a chemical bond to be activated by a catalyst to be described later and a bondable group X to form a chemical bond to the working electrode 121 is prepared as the polymerization initiator 37.

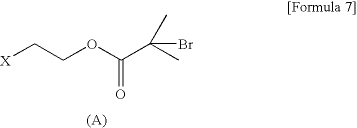

Here, if the working electrode 121 is formed of a metal material such as Au, Ag, Pt or Cu, or alloys containing these metals, for example, a thiol group (SH group), a disulphide group (—SS-group), a monosulfide group (—S-group) or a carboxyl group (—COOH group) is selected as the bondable group X.

On the other hand, if the working electrode 121 is formed of an oxide material, for example, an alkoxysilyl group or a halogeno silyl group, which is a hydrolyzable group to generate a silanol group, is selected as the bondable group X.

For example, if the bondable group X is a SH group, the SH group is reacted with the top surface of the working electrode 121.

This causes the polymerization initiator 37 to be bound (linked) onto the working electrode 121 through a metal-thiol bond (—S—).

This can be done, e.g., by selectively bringing a solution containing the polymerization initiator 37 represented by the above compound (A) into contact with the top surface of the working electrode 121.

As a method for selectively bringing this solution into contact with the top surface of the working electrode 121, various liquid phase film formation methods are used.

Among them, a droplet discharge method is preferably used.

By a process as described above, the polymerization initiator 37 is fixed (solid phased) onto the top surface of the working electrode 121 as illustrated in FIG. 7.

3B. Next, a first monomer having the ion-trapping part 322 is prepared.

Examples of a polymerization group that the first monomer has include groups containing carbon-carbon double bonds, such as a (meta) acryloyl group, a vinyl group and a styryl group, and groups that cause a ring-opening reaction, such as a norbornyl group, an epoxy group and an oxetanyl group.

In terms of relatively high polymerization activity and low costs, a monomer containing a (meta) acryloyl group is preferably used.

As a specific example of the first monomer a compound represented by the following chemical formula (B) may be mentioned.

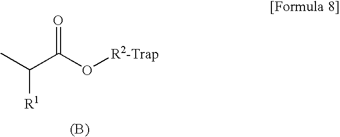

where Trap represents the ion-trapping part 322, R¹ represents a hydrogen atom or a methyl group, and R² represents a methylene group or an ethylene group.

Among the first monomers, the compound represented by the above chemical formula (B) that contains the ion-trapping part 322 can be synthesized, e.g., by the following way.

First, after the ion-trapping part 322 (ionophore) is dissolved in dichloroimethane (DCM), Na₂Fe(CO)₄ is added and mixed.

Then, an oxygen gas is supplied to introduce a hydroxyl group into part of the ion-trapping part 322.

At this point, as reaction conditions in introducing a hydroxyl group into the ion-trapping part 322, the reaction temperature is 0° C. and the reaction time is 30 minutes.

Next, the ion-trapping part 322 in which a hydroxyl group has been introduced is dissolved in an ether such as diethyl ether or tetrahydrofuran (THF).

A basic catalyst such as pyridine, trimethylamine or dimethylamine is added to a solution obtained in this way and then a substituted or unsubstituted acryloyl chloride is added, thereby introducing a substituted or unsubstituted acryloyl group into the terminal of the ion-trapping part 322.

In such a way as described above, a compound (first monomer) containing the ion-trapping part 322, which is represented by chemical formula (B), is obtained.

3C. Next, a second monomer having the electron transfer assistance part 342 is prepared.

As a polymerization group that the second monomer has, a monomer containing a (meta)acryloyl group is preferable from the same reason as mentioned for the first monomer.

As a specific example of the second monomer, a compound represented by the following chemical formula (C) may be mentioned.

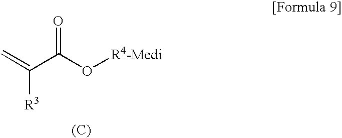

where Medi represents the electron transfer assistance part 342, R³ represents a hydrogen atom or a methyl group, and R⁴ represents a methylene group or an ethylene group.

Among the second monomers, the compound containing the electron transfer assistance part 342, which is represented by chemical formula (C), can be synthesized in the same way as for the compound containing the ion-trapping part 322, which is represented by chemical formula B), except for preparing Medi (the electron transfer assistance part 342) in place of Trap (the ion-trapping part 322).

3D. Next, with the polymerization initiator 37 (a compound represented by chemical formula (A)) fixed onto the top surface of the working electrode 121 used as a base point, the first monomer and the second monomer are alternately or randomly polymerized by living polymerization (particularly atom transfer radical polymerization (ATRP)) to synthesize the polymer 3.

For example, the living polymerization can be carried out in such a way that a solution containing a catalyst is supplied to the inside of the opening 165, and then the first monomer and the second monomer are simultaneously or subsequently added to the solution.

The catalyst may be one that can activate the growth terminal in a growth process of a polymer.

Examples of the catalyst include halides, hydroxides and oxides of transition metals, alkoxides, cyanides, cranates, thiocyanates and azide compounds, and may also include transition metal complexes having general ligands of transition metals, such as bipyridyl, phosphine and carbon monoxide.

Among these examples, catalysts having a halide of transition metal as a main component are preferable.

The catalysts having a halide of transition metal as a main component are preferable because they are suitable for living polymerization.

In addition, they are preferable because they can be obtained with ease at relatively low costs and are easy to handle.

Examples of the transition metal include Cu, Fe, Au, Ag, Hg, Pd, Pt, Co, Mn, Ru, Mo, Nb and Zn.

Examples of a solvent used as a reaction field for synthesization of the polymer 3 include water; alcohols such as methanol, ethanol and butanol; halogenated aromatic hydrocarbons such as o-dichlorobenzene; and ethers such as diethyl ether and tetrahydrofuran.

By acting the first monomer in the presence of the polymerization initiator 37 and a catalyst, a bond contained in the polymerization initiator 37 is activated by the catalyst to be chemically combined with the first monomer, an atom contained in the bond activated by the catalyst in the polymerization initiator 37 moves into the first monomer, and the bond activated by the catalyst is regenerated as the growth terminal.

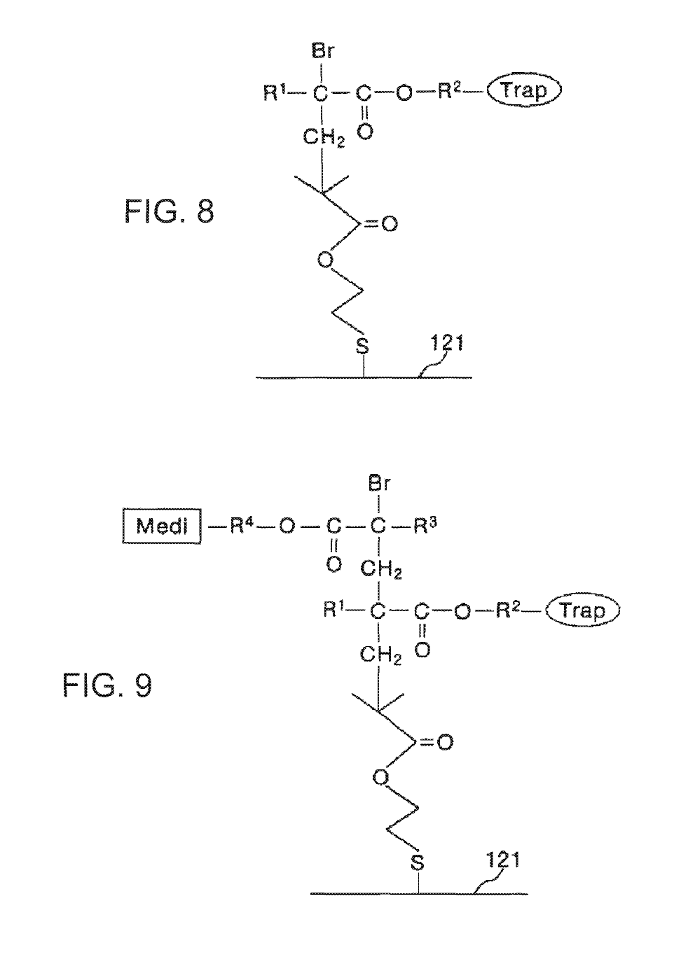

For example, using a compound represented by chemical formula (B) as the first monomer and CuBr as the catalyst allows the first monomer to be chemically combined to the polymerization initiator 37 and the growth terminal to be formed at the tip (upper end) as illustrated in FIG. 8.

When the second monomer is added to the foregoing solution, the second monomer is chemically combined to the first monomer in the same way as described above.

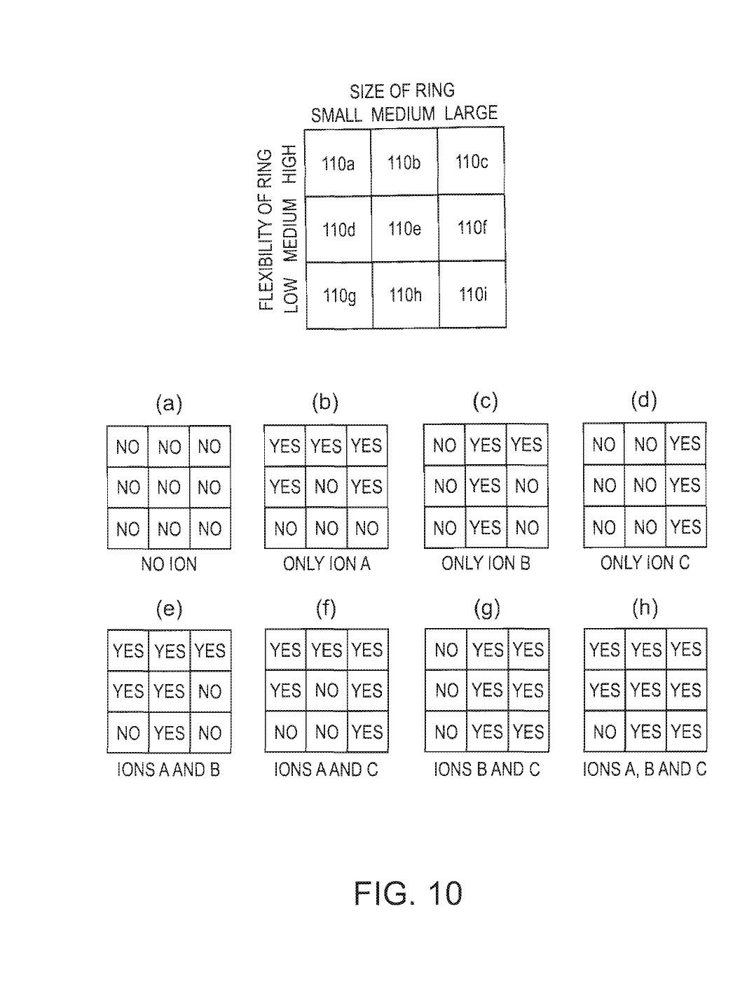

For example, using a compound represented by chemical formula (C) as the second monomer allows the second monomer to be chemically combined to the first monomer and the growth terminal to be formed at the tip (upper end) as illustrated in FIG. 9.

Here, in living polymerization, the growth terminal continually has polymerization activity in a growth process of the polymer 3.

Accordingly, after monomers are consumed and the polymerization reaction stops, the polymerization reaction restart when new monomers are added.

Therefore, the numbers of the ion-trapping part 322 and the electron transfer assistance part 342 in the polymer 3 can be controlled with accuracy by changing the amount of monomers supplied to a reaction system.

In this way, the polymer 3 having a desired molecular structure can be formed on the top surface of the working electrode 121 by simple processes.

Also, irregularity in characteristics among the obtained polymers 3 can be suppressed.

The foregoing solution (reaction liquid) is preferably subjected to deoxygenation prior to the start of a polymerization reaction.

Examples of the deoxygenation include substitution with an inactive gas such as an argon gas or a nitrogen gas after vacuum degassing, and purging.

In a polymerization reaction, heating the foregoing solution to increase the temperature to a predetermined temperature (temperature at which each monomer and the catalyst is activated) allows the polymerization reaction of each monomer more promptly and securely.

The heating temperature slightly differs depending on the heat resistant temperatures of the ion-trapping part 322 and the electron transfer assistance part 342 and the kind of the catalyst and is not particularly limited, but is preferably about 20 to 50° C.

The heating time (reaction time) is preferably about 10 to 20 hours under the condition of the heated temperature within the range mentioned above.

By processes as described above, the detection element 100 illustrated in FIG. 1 is obtained.

Next, how to use the detection element 100 as described above, that is, a method for detecting the amount of the targets 4 in the analyte will be described.

Here, a case of the targets 4 being ions will be explained as one example.

I. First, the analyte liquid 151 to be evaluated, that is, the analyte liquid 151 containing the targets 4 is prepared.

II. Next, the detection element 100 is prepared and the analyte liquid 151 is injected (supplied) into the detector (well) 110.

When the analyte liquid 151 has been supplied into each detector 110, the targets 4 are trapped into the ion-trapping parts 322 if the targets (ions) 4 are contained in the analyte liquid 151 as illustrated in FIG. 4B.

III. Then, in this state, an electric current value taken out from the working electrode 121 is detected (measured).

In this way, it can be determined whether ions to be detected exist in the analyte liquid 151 (that is, in the analyte), and further the amount of the ions can be obtained, e.g., on the basis of a working curve and a table measured in advance.

In general, there are a very few ion-trapping parts 322 that specifically trap single ions.

Nonetheless, general ion-trapping part 322 can detect the amount of single ions in the analyte liquid 151 by the following technique.

FIG. 10 explains a method for detecting the amount of single ions.

It should be noted that “YES” in FIG. 10 indicates that an ion is detected whereas “NO” indicates that the no ion is detected.

Explanation is given provided that the sizes of ions A, B and C are A<B<C.

In examples illustrated in FIG. 10, the kind of the ion-trapping parts 322 (ionophore) included in the reaction layer 140 differs for each of detectors 110a to 110i such that the inside space of a cyclic structure increases from left to right and the flexibility of the cyclic structure decreases from top to bottom.

First, a sample containing no ion is used, all the detectors 110a to 110i are marked with “NO” as indicated in FIG. 10(a).

If a sample containing at least one of ions A, B and C is used, specific detectors are marked with “YES” as indicated in FIG. 10(b) to (h).

Specifically, if a sample containing only ion A is used, detectors 110a to 110d and 110f are marked with “YES” in FIG. 10(a).

If the pattern indicated in FIG. 10(e) is detected for an actual analyte liquid 151, it is found that ions A and B exist in this analyte liquid 151.

In order to detect the amount of ion A, detectors that are marked with “YES” for a sample containing only ion A and marked with “NO” for a sample containing only ion B, specifically detectors 110a, 110b and 110f, are used.

That is, the amount of ion A may be obtained on the basis of electric current values detected by the detectors 110a, 110b and 110f.

On the other hand, in order to detect the amount of ion B, the amount of ion B may be obtained on the basis of electric current values detected by the detectors 110c and 110h.

### Second Embodiment

A second embodiment of the detection element will now be described.

A detection element in the second embodiment is described below, in which a description is made mainly for the differences from the first embodiment and the common explanation is omitted.

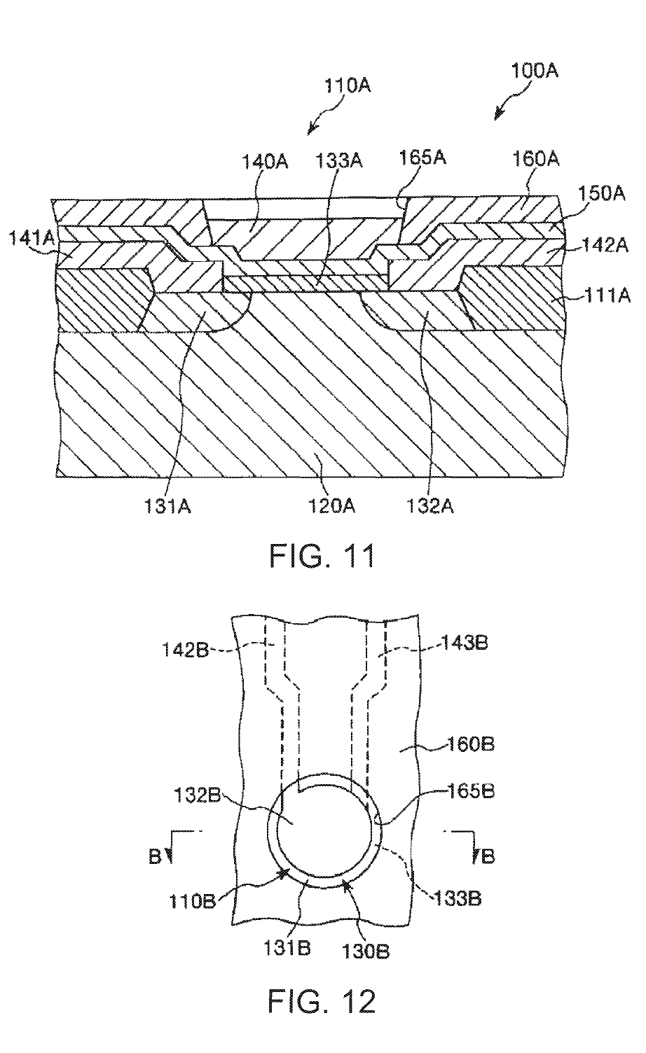

FIG. 11 is a longitudinal sectional view illustrating a detector that a detection element in the second embodiment has.

It should be noted that the upper and lower sides in the description below mean the upper and lower sides of the drawing in FIG. 11.

A detection element 100A illustrated in FIG. 11 has a semiconductor substrate 120A and a trench isolation structure 111A that isolates detectors 110A from each other.

On one surface of a semiconductor substrate 120A, a source region 131A and a drain region 132A apart from each other are disposed inside the trench isolation structure 111A.

A source electrode 141A is disposed to be in contact with a source region 131A, and a drain electrode 142A is disposed to be in contact with a drain region 132A.

A gate insulating film 133A is disposed to be in contact with the source region 131A and the drain region 132A.

An insulating film 150A is disposed to cover the source electrode 141A, the drain electrode 142A and the gate insulating film 133A.

An insulating film 160A that has an opening 165A corresponding to the gate insulating film 133A is provided.

Disposed on the top surface of the insulating film (base) 150A in the opening 165A is a reaction layer 140A.

The semiconductor substrate 120A is made of a p-type semiconductor material such as silicon. In this case, an n-type impurity such as boron (B), aluminum (Al) and gallium (Ga) is implanted into the source region 131A and the drain region 132A.

The source electrode 141A and the drain electrode 142A are made of conductive materials, which are metals such as Al, Ni, Cu and Pt or alloys containing these metals.

The gate insulating film 133A and the insulating film 150A are made of insulating materials such as SiO₂ and Si₃N₄.

The insulating film 160A and the reaction layer 140A may have the same structure as those of the insulating film 160 and the reaction layer 140 of the first embodiment, and may be formed in the same way as in the first embodiment.

Here, if the insulating film 150A is made of Si₃N₄, the top surface is subjected to an oxidation treatment.

This treatment enables the top surface of the insulating film 150A to become SiO₂.

Therefore, by using the polymerization initiator 37 having a hydrolyzable group that a silanol group generates or the like as a bondable group X, the polymer 3 attached onto the top surface of the insulating film 150A can be formed (synthesized).

In the detection element 100A as described above, when the analyze liquid 151 is supplied to the detector 110A, ions and salts are trapped into the ion-trapping parts 322 if they exist in the analyte liquid 151.

Accordingly, the amount (concentration) of carriers excited on the top surface of the gate insulating film 133A varies in accordance with the kind and the amount of trapped ions.

As a result, the electric current value flowing between the source electrode 141A and the drain electrode 142A, that is, the electric current value that can be taken out from the drain electrode 142A varies.

### Third Embodiment

A third embodiment of the detection element said now be described.

A detection element in the third embodiment is described below, in which a description is made mainly for the differences from the first embodiment and the common explanation is omitted.

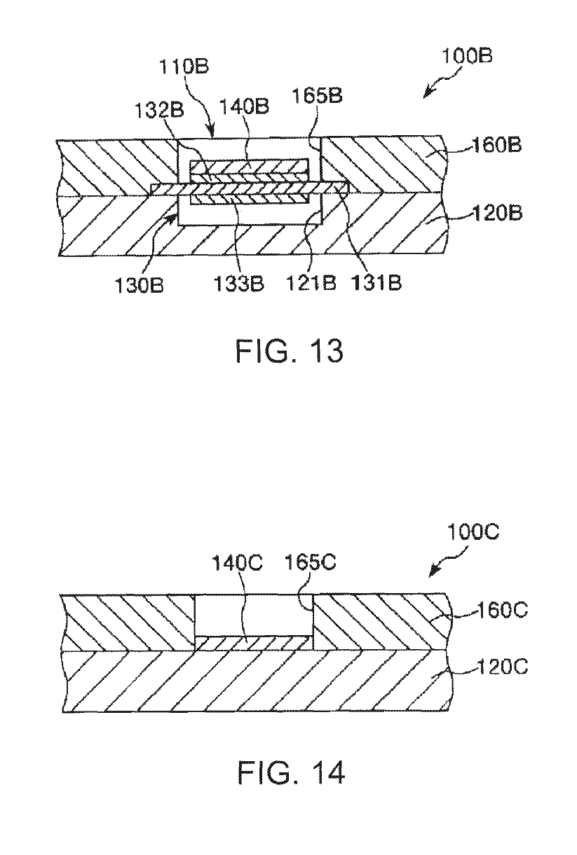

FIG. 12 is a plan view illustrating a detector that a detection element in the third embodiment has, and FIG. 13 is a sectional view taken along the line B-B in FIG. 12.

It should be noted that the upper and lower sides in the description below mean the upper and lower sides of the drawing in FIG. 12.

A detection element 100B of the third embodiment detects the difference between the trapping state and the non-trapping state on the basis of a variation in mass of a reaction layer 140B in place of a variation in electric characteristics of the reaction layer 140, and is the same as the detection element 100 of the first embodiment on other points.

That is, in the detection element 100B illustrated in FIGS. 12 and 13, each detector 110B is provided with a piezoelectric element 130B.

The piezoelectric element 130B includes a piezoelectric member 131B having a flat-plate shape, and upper and lower electrodes 132B and 133B disposed on both sides thereof.

The electrodes 1323 and 133B, which are independent of each other, are electrically coupled to the processing circuit 200 through wirings 142B and 143B, respectively.

A recess 121B is disposed in a substrate 120B.

An edge of the piezoelectric member 131B is fixed (fastened) to the substrate 120B such that the lower electrode 133B (and the upper electrode 132B) corresponds to the recess 121B.

As the constituent materials for the electrodes 132B and 133B, the same material as that for the working electrode 121 may be used.

As the material for the piezoelectric member 131B, piezoelectric materials such as quartz crystal, lithium niobate, lithium tantalite and lithium borate may be used.

It should be noted that these materials may be used alone or in a combination of two or more kinds (e.g., laminate).

The insulating film 160B has an opening 165B, and the upper electrode 132B is exposed from the opening 165B.

The reaction layer 140B is disposed on the top surface of the upper electrode 132B.

The insulating film 160B and the reaction layer 140B may have the same structures as those of the insulating film 160 and the reaction layer 140 of the first embodiment, and may be formed in the same way as in the first embodiment.

In the detection element 100B as described above, when the analyte liquid 151 is supplied to the detector 110B, ions and salts are trapped into the ion-trapping parts 322 if they exist in the analyte liquid 151.

Accordingly, the mass of the reaction layer 140B varies.

This causes the number of vibrations detected from the piezoelectric element 130B to vary.

By detecting this variation, the amount of the targets 4 in the analyte can be detected (measured).

### Fourth Embodiment

A fourth embodiment of the detection element will now be described.

A detection element in the fourth embodiment is described below, in which a description is made mainly for the differences from the first embodiment and the common explanation is omitted.

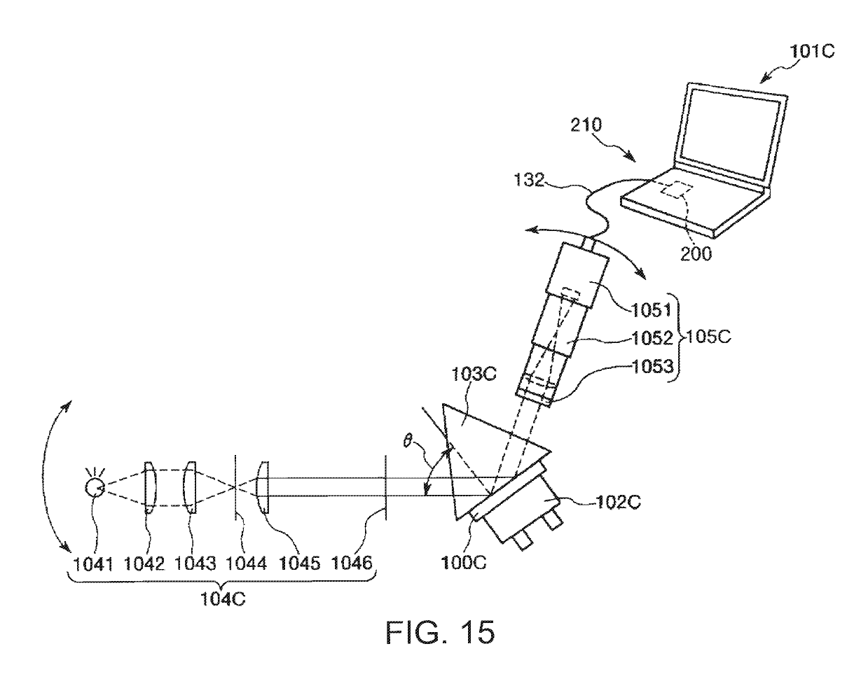

FIG. 14 is a longitudinal sectional view illustrating a detector that a detection element in the fourth embodiment has, and FIG. 15 is a schematic view (perspective view) illustrating a configuration of a measurement device to which the detection element illustrated in FIG. 14 is applied.

It should be noted that the upper and lower sides in the description below mean the upper and lower sides of the drawings in FIGS. 14 and 15.

A detection element 100C of the fourth embodiment detects the difference between the trapping state and the non-trapping state on the basis of a variation in refractive index of a reaction layer 140C in place of a variation in electric characteristics of the reaction layer 140, and is the same as the detection element 100 of the first embodiment on other points.

That is, the detection element 100C illustrated in FIG. 14 includes a metal substrate 120C, an insulating film 160C having an opening 165C, and the reaction layer 140C disposed on the top surface of the metal substrate 120C exposed from the insulating film 160C (opening 165C).

The detection element 100C can detect the amount of the targets 4 in the analyte (the analyte liquid 151) based on a variation of the reaction layer 140C resulting from a variation in film thickness of the reaction layer 140C (length of the polymer 3).

As the constituent material for the metal substrate 120C, the same material as that for the working electrode 121 may be used.

The insulating film 160C has an opening 165C, and the reaction layer 140C is exposed from the opening 165C.

The insulating film 160C and the reaction layer 140C may have the same structures as those of the insulating film 160 and the reaction layer 140 of the first embodiment, and may be formed in the same way as in the first embodiment.

A measurement device 101C for use in measurement of the detection element 100C as described above includes a mounting unit 102C for mounting and fixing the detection element 100C, a prism (optical path change means) 103C placed on the top surface of the detection element 100C, light transmitting means (illumination means) 104C for illuminating the detection element 100C, light receiving means 105C for receiving light from the detection element 100C, an arithmetic unit 210 having a processing circuit 200 for analyzing data (e.g., image data) obtained by the light receiving means 105C, and wiring 132 for connecting the processing circuit 200 with the light receiving means 105C.

The light transmitting means 104C includes a light source 1041, a pair of plano-convex lenses 1042 and 1043 arranged such that the convex curved surfaces face each other, a pinhole board 1044 arranged on the opposite side to that of the light source 1041 with respect to these lenses, a plano-convex lens 1045 for causing light beams that have passed through the pinhole board 1044 to become parallel light beams, and a polarization filter 1046 through which p-polarized light beams are selectively passed.

On the other hand, the light receiving means 105C includes a CCD camera 1051 connected through the wiring 132 to the arithmetic unit 210, light guide means (lens system) 1052 for guiding light from the detection element 100C to the CCD camera 1051, and an interference filter 1053 arranged on the opposite side to that of the CCD camera 1051 of the light guide means 1052.

The light transmitting means 104C and the light receiving means 105C are provided to be separates rotatable with respect to the detection element 100C (prism 103C) as illustrated in FIG. 15.

In this way, light transmitted at any angle from the light transmitting means 104C can be received in the light receiving means 105C.

In the detection element 100C and the measurement device 101C as described above, the amount of the targets 4 in the analyte liquid 151 can be detected measured) utilizing surface plasmon resonance (SPR).

SPR is based on the following principles.

That is, when light emitted from the light transmitting means 104C is incident upon an interface between the prism 103C and the reaction layer 140C, an evanescent wave is created.

Its wave number is defined by the following equation:

kev=kₚ·nₚ·sin θ

where kₚ is a wave number of incident light, nₚ is a refractive index of the prism 103C, and θ is an incident angle.

On the other hand, a surface plasmon wave is created on the surface of the metal substrate 120C (interface with the reaction layer 140C), its wave number is defined by the following equation:

Kₛₚ=(c/ω)·√(εn²/(ε+n²))

where c is a speed of light, ω is an angular frequency, ε is a dielectric constant of the metal substrate 120C, and n is a refractive index of the reaction layer 140C.

With an incident angle θ at which the wave number of the evanescent wave agrees with that of the surface plasmon wave, the evanescent wave is used for excitation of surface plasmon.

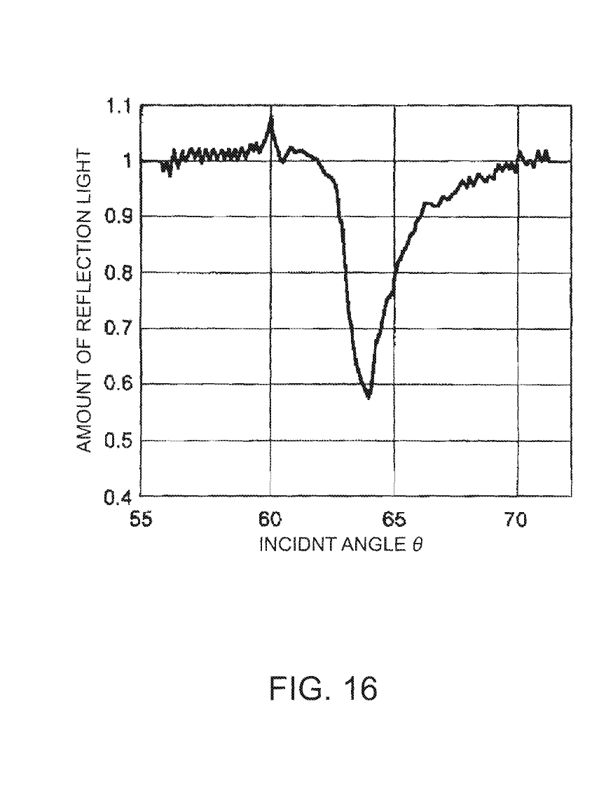

For example, the amount of light observed as reflection light decreases as illustrated in FIG. 16.

The SPR phenomenon is dependent on the refractive index of the reaction layer 140C in contact with the prism 103C and the metal substrate 120C.

Therefore, for example, a variation in refractive index of the reaction layer 140C is measured on the basis of a variation in film thickness of the reaction layer 140C, thereby enabling the targets 4 trapped in the reaction layer 140C (polymer 3) to be detected (e.g., quantitative determination).

The measurement device 101C is configured as illustrated in FIG. 15 thereby enabling a plurality of detectors 110C to be collectively detected.

A detection element of the invention has been described above based on the embodiments with reference to the accompanying drawing, but the invention is not limited to the embodiments.

For example, regarding a detection element of the invention, structures of elements thereof may be replaced by any structures having the same functions as those of the embodiments, and any structures may be added.

What is claimed is:

1. A detection element, comprising a detector by which one of a salt and an ion in an analyte is detectable, the detector including a base and a reaction layer disposed on the base, the reaction layer having a polymer, the polymer having:
a main chain with an end thereof linked to the base; and
a side chain branched from the main chain, the side chain containing an ion-trapping part in which one of an ion constituting the salt and the ion is trappable.

2. The detection element according to claim 1, wherein the ion-trapping part has a cyclic structure and has a function of trapping the ion into the cyclic structure based on a difference in kind and/or ion size of the ion.

3. The detection element according to claim 2, wherein the cyclic structure contains at least one kind of an oxygen atom, a nitrogen atom and a sulfur atom.

4. The detection element according to claim 2, wherein the ion-trapping part further has a coordination structure for coordination to the ion trapped in the cyclic structure.

5. The detection element according to claim 4, wherein the coordination structure is located between the cyclic structure and the main chain.

6. The detection element according to claim 1, wherein the detector includes a plurality of detectors.

7. The detection element according to claim 2, wherein:
the detector includes a plurality of detectors; and
the plurality of the detectors each have a different kind of the cyclic structure.

8. The detection element according to claim 1, wherein the detection element is configured to detect a difference between a non-trapping state where the polymer has the ion without being trapped in the ion-trapping part and a trapping state where the polymer has the ion trapped in the ion-trapping part based on a variation in electric characteristic of the reaction layer.

9. The detection element according to claim 8, wherein the polymer has an electron transfer assistance part for assisting transfer of an electron.

10. The detection element according to claim 9, wherein the polymer has the electron transfer assistance part in a side chain branched from the main chain.

11. The detection element according to claim 11, wherein the detection element is configured to detect a difference between a non-trapping state of the polymer without the ion trapped in the ion-trapping part and a trapping state of the polymer with the ion trapped in the ion-trapping part based on a variation in mass of the reaction layer.

12. The detection element according to claim 1, wherein the detection element is configured to detect a difference between a non-trapping state of the polymer without the ion trapped in the ion-trapping part and a trapping state of the polymer with the ion trapped in the ion-trapping part based on a variation in refractive index of the reaction layer.
